(19) United States
(12) Patent Application Publication
(10) Pub. No.: US 2013/0120629 A1
(43) Pub. Date: May 16, 2013

(54) PHOTOGRAPHING APPARATUS AND PHOTOGRAPHING METHOD

(71) Applicants: Dae-myung Kim, Hwaseong-si (KR); Dae-hyun Kim, Hwaseong-si (KR)

(72) Inventors: Dae-myung Kim, Hwaseong-si (KR); Dae-hyun Kim, Hwaseong-si (KR)

(73) Assignee: Samsung Electronics Co., Ltd., Suwon-si (KR)

(21) Appl. No.: 13/600,774

(22) Filed: Aug. 31, 2012

(30) Foreign Application Priority Data
Nov. 14, 2011 (KR) 10-2011-0118511

(51) Int. Cl. H04N 5/222

(52) U.S. Cl. 348/333.01; 348/E05.022

(57) ABSTRACT

A photographing apparatus including a main body; an imaging unit installed in the main body configured to convert light incident on a subject into a signal representing an image; a first display unit comprising a first region formed of a transparent material, wherein the first region is configured to transmit light incident to the subject passing through the first region and configured to display the image overlapped with the transmitted light if a signal is applied, and disposed on the main body to be movable between a protruding position where the first region protrudes from the main body and a receiving position where the first region is received in the main body; and a control unit installed in the main body configured to control the imaging unit, and configured to apply the signal to the first display unit to display the image overlapped with the transmitted light.

### CROSS-REFERENCE TO RELATED PATENT APPLICATION

This application claims the benefit of Korean Patent Application No. 10-2011-0118511, filed on Nov. 14, 2011, in the Korean Intellectual Property Office, the entire disclosure of which is incorporated herein by reference.

### BACKGROUND

1. Field of the Invention

The invention relates to a photographing apparatus and a photographing method, and more particularly, to a photographing apparatus and a photographing method capable of realizing an optical view finder and an electronic view finder by including a transparent display that displays an image while transmitting light.

2. Description of the Related Art

Consumers want photographing apparatuses such as digital cameras or digital camcorders to be reduced in size. A consumer of single lens reflex cameras or twin-lens reflex cameras may prefer using an optical view finder, through which the consumer may identify an image of a subject that is to be photographed by the actual light incident to the subject.

According to the invention disclosed in KR 2010-0114419, optical elements such as a pentaprism, a lens, and a mirror are necessary to realize an optical view finder. However, including optical elements for an optical view finder increases the size of the digital apparatus, which makes it difficult to provide a reduced sized digital apparatus for the consumer.

### SUMMARY

Therefore, there is a need in the art for a photographing apparatus and method, the photographing apparatus including a main body; an imaging unit installed in the main body configured to convert light incident on a subject into a signal representing an image; a first display unit comprising a first region formed of a transparent material, wherein the first region is configured to transmit light incident to the subject passing through the first region and configured to display the image overlapped with the transmitted light if a signal is applied, and disposed on the main body to be movable between a protruding position where the first region protrudes from the main body and a receiving position where the first region is received in the main body; and a control unit installed in the main body configured to control the imaging unit, and configured to apply the signal to the first display unit to display the image overlapped with the transmitted light.

When the first display unit moves to the protruding position, the first region may display information about a photographing region so that the information may overlap with the light passing through the first region.

The first display unit may further include a second region that is connected to the first region to display an image when a signal is applied to the second region, and the second region may be connected to the main body while the first region moves to the protruding position.

The second region may display information for a photographing operation.

The first display unit may be disposed to be slideable with respect to the main body.

The photographing apparatus may further include a flexible circuit board, an end of which is connected to the first display unit and the other end of which is connected to the control unit, transmitting a signal between the control unit and the first display unit.

The main body may include guide portions supporting the first display unit slideably, and the guide portions may include a connecting portion maintaining an electric connection to the first display unit that slides along the guide portions, and the connecting portion may be electrically connected to the control unit.

The first display unit and the control unit may be wireless communicated with each other.

The first display unit may be rotatable along a surface that is parallel to a surface of the main body.

The first display unit may be rotatable in a direction perpendicular to the surface of the main body.

The main body may include a protrusion portion that protrudes outward from the main body so as to support the first region when the first display unit is in the protruding position, and the protrusion portion may include a through hole for transmitting the light to the first region.

The photographing apparatus may further include a light shielding portion installed on the protrusion portion to block the through hole when a signal is applied to the light shielding portion.

The photographing apparatus may further include a light shielding portion coupled to the first region and blocking the light passing through the first region when a signal is applied to the light shielding portion.

The first display unit may be disposed on a rear surface of the main body, and the photographing apparatus may further include a second display unit disposed on a side of the first display unit to display an image when a signal is applied to the second display unit.

The first display unit may be disposed on a front surface of the main body, and the photographing apparatus may further include a second display unit disposed on a rear surface of the main body to display an image according to a signal.

The photographing apparatus may further include a user input unit for selecting a part on the first region of the first display unit, and the second display unit may display an expanded image of the selected part on the first region of the first display unit.

The user input unit may include a touch screen disposed on a surface of the first region.

According to another aspect of the invention, there is provided a photographing method including: moving a first display unit that includes a first region, which is formed of a transparent material that transmits light and may display an image overlapped with the light passing through the first region when a signal is applied, with respect to a main body so that the first region protrudes out of the main body; providing an optical view finder image by transmitting the light through the first region that protrudes out of the main body; and converting the light incident into the first region from at least a part of a subject into a signal representing an image by using an imaging unit disposed in the main body.

The providing of the optical view finder image may include displaying an image on the first region to be overlapped with the light transmitting through the first region.

The first display unit may further include a second region that is connected to the first region and displays an image according to an applied signal, the second region may be connected to the main body while the first region moves to a protruding position where the first region protrudes from the main body, and the providing of the optical view finder image may further include displaying information for a photographing on the second region.

### BRIEF DESCRIPTION OF THE DRAWINGS

The above and other features and advantages of the invention will become more apparent by describing in detail exemplary embodiments thereof with reference to the attached drawings in which:

FIG. 1 is a schematic block diagram of an example of a photographing apparatus according to an embodiment of the invention;

FIG. 2 is a diagram illustrating an operation of the photographing apparatus of FIG. 1;

FIG. 3 is a rear view illustrating an example operation of the photographing apparatus of FIG. 2;

FIG. 4 is a rear view showing another example operation of the photographing apparatus of FIG. 2;

FIG. 5 is an expanded view illustrating example magnified parts of the photographing apparatus of FIG. 1;

FIG. 6 is a schematic view showing some parts of an example of a photographing apparatus according to another embodiment of the invention;

FIG. 7 is a schematic view showing some parts of an example of a photographing apparatus according to another embodiment of the invention;

FIG. 8 is a perspective view of an example of a photographing apparatus according to another embodiment of the invention;

FIG. 9 is a perspective view of an example of a photographing apparatus according to another embodiment of the invention;

FIG. 10 is a rear view of an example of a photographing apparatus according to another embodiment of the invention;

FIG. 11 is a side view schematically showing components of an example of a photographing apparatus according to another embodiment of the invention; and

FIG. 12 is a flowchart illustrating processes of an example of a photographing method according to an embodiment of the invention.

### DETAILED DESCRIPTION

Hereinafter, structures and operations of a view finder device according to embodiments of the invention will be described in detail with reference to accompanying drawings.

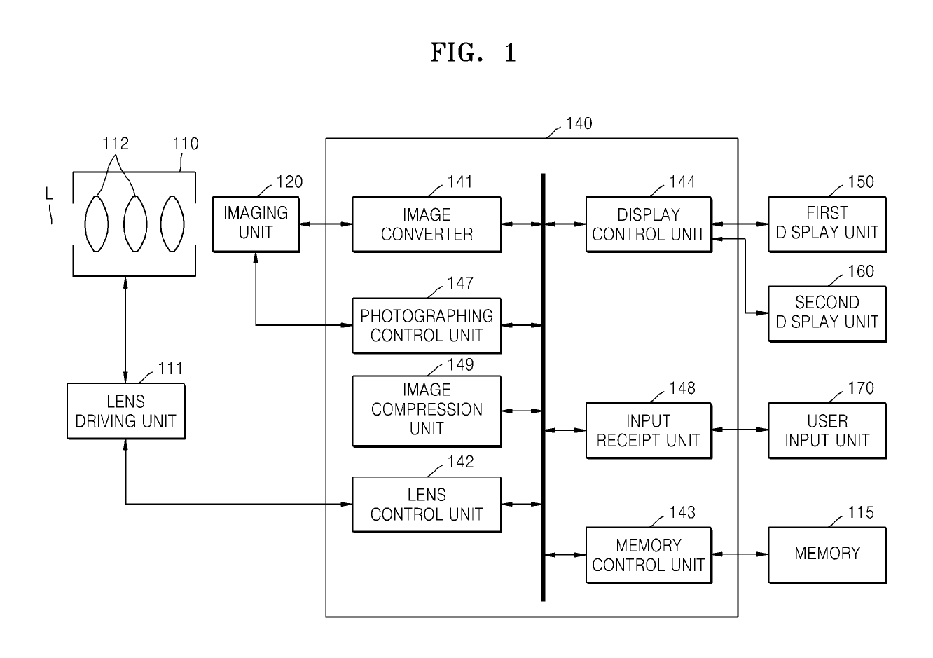

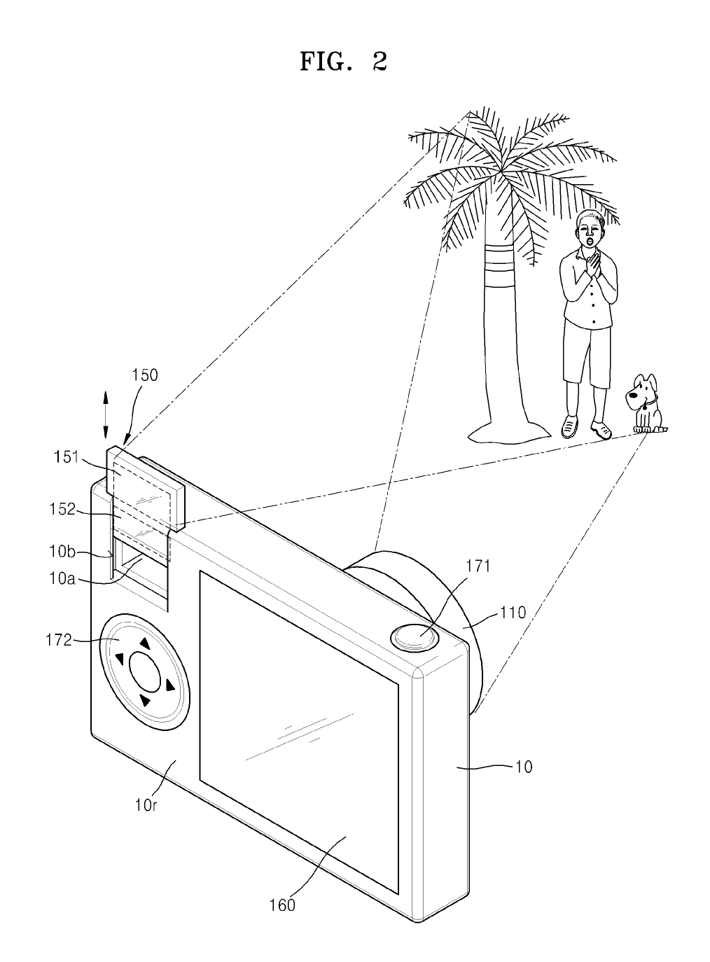

FIG. 1 is a block diagram schematically illustrating an example of a photographing apparatus according to an embodiment of the invention, and FIG. 2 is a diagram illustrating an operation of the photographing apparatus of FIG. 1. FIG. 1 shows relations between components included in a main body 10 shown in FIG. 2.

The photographing apparatus shown in FIGS. 1 and 2 includes a main body 10, an imaging unit 120 installed in the main body 10 and converting light into a signal representing an image, a first display unit 150 disposed on the main body 10 to be movable, and a control unit 140 controlling other components.

The photographing apparatus according to the embodiment may be a digital still camera taking still images or a digital video camera taking moving pictures.

The main body 10 surrounds various components of the photographing apparatus to protect and support the components. The imaging unit 120 is installed on the main body 10.

The imaging unit 120 photographs a subject and converts an image of the subject into an electric signal. The electric signal generated by the imaging unit 120 is converted into image data by an image converter 141. A photographing control unit 147 of the control unit 140 controls the imaging unit 120 to perform a photographing operation.

A lens barrel 110 disposed in front of the imaging unit 120 includes a plurality of lenses 112 to form an optical system. An external light from a subject passes through the plurality of lenses 112, and forms images on an imaging surface of the imaging unit 120. The lens barrel 110 may be fixed onto the main body 10 of the camera, or may be detachably coupled to the main body 10 if the camera is designed as an interchangeable lens camera.

The plurality of lenses 112 are arranged such that distances between the lenses 112 may be variable. When the distances between the lenses 112 are changed, zoom magnification or focus may be adjusted. The lenses 112 are arranged along an optical path L, which denotes a virtual straight line connecting optical centers of the lenses 112.

The lenses 112 are driven by a lens driving unit 111 that has a driving unit such as a zoom motor (not shown) so as to change locations with respect to each other. The lenses 112 may include a zoom lens for magnifying or reducing a size of the subject, and a focusing lens for focusing the subject.

The lens driving unit 111 receives a control signal from a lens control unit 142 of the control unit 140, and controls locations of the lenses 112 so that the lenses 112 may have one of a plurality of magnifications.

The imaging unit 120 includes a photoelectric conversion device such as a charge coupled device (CCD) or a complementary metal oxide semiconductor (CMOS) to convert the light of the subject incident through the lenses 112 into an electric signal. The imaging unit 120 operates on receiving a control signal applied from the photographing control unit 147.

The image converter 141 converts the electric signal of the imaging unit 120 into image data so as to perform an image process or to store the image data in a storage medium such as a memory 115. For example, the image converter 141 converts the electric signal of the imaging unit 120 into red (R), green (G), and blue (B) data, and then, converts the RGB data into raw data such as a YUV signal including a brightness (Y) signal and a color difference (UV) signal.

In addition, conversion processes of the electric signal of the imaging unit 120 by the image converter 141 may include sub-processes, for example, reducing driving noise of the imaging unit 120 included in the electric signal by using a correlated double sampling (CDS) circuit, adjusting gain of the electric signal after the noise reduction by using an automatic gain control (AGC) circuit, converting an analog signal into a digital signal using an analog/digital (A/D) converter, a pixel defect correcting, a gain correcting, and gamma-correcting of the digital signal. The CDS circuit, the AGC circuit, or the A/D converter may be configured as additional circuits.

The control unit 140 is electrically connected to the imaging unit 120, the lens driving unit 111, a first display unit 150, a second display unit 160, a user input unit 170, and the memory 115, and transmits control signals to the components for controlling operations of the components or processes data.

The control unit 140 includes the image converter 141, the lens control unit 142, a memory control unit 143, a display control unit 144, a photographing control unit 147, an input receipt unit 148, and an image compression unit 149.

The control unit 140 may be realized as a micro chip, or a circuit board including a micro chip. In addition, components included in the control unit 140 may be realized by software or circuits built in the control unit 140.

The memory control unit 143 controls recording of data in the memory 115, and reading of the recorded data or setting information from the memory 115.

The memory 115 may be a volatile built-in memory, for example, may be formed of a semiconductor memory device such as synchronous dynamic random access memory (SDRAM). The memory 115 functions as a buffer memory that temporarily stores the image data generated by the image converter 141 and an operation memory used to process data.

The memory 115 may be a non-volatile external memory, for example, a flash memory such as a memory stick or a secured digital (SD)/multimedia card (MMC), a storage apparatus such as a hard disk drive (HDD), or an optical storage apparatus such as a digital versatile disc (DVD) or a compact disc (CD). In the memory 115, image data that is compressed and converted into a format such as a Joint Photographic Experts Group (JPEG) file, a tagged image file (TIF) file, a graphics interchange format (GIF) file, or a PC paintbrush (PCX) file may be stored.

In an embodiment, the first display unit 150 and the second display unit 160 are disposed on a rear surface 10r of the main body 10 of the photographing apparatus. The second display unit 160 may be realized by a display device such as a liquid crystal display (LCD) or an organic light emitting diode (OLED). In addition, a touch panel that senses touches on a surface thereof and generates signals corresponding to sensed locations may be disposed on a surface of the second display unit 160.

Referring to FIG. 2, a menu button 172 and the first display unit 150 are disposed on a side portion of the second display unit 160 on the rear surface 10r of the main body 10 of the photographing apparatus. The menu button 172 is an example of the user input unit 170 shown in FIG. 1. In addition, a shutter button 171 corresponding to another example of the user input unit 170 is disposed on an upper edge portion of the main body 10.

The first display unit 150 is formed of a transparent material that transmits the light, and may display an image that overlaps with the light passing through the first display unit 150 or may transmit the light without displaying an image depending on a signal applied from the control unit 140. The first display unit 150 may be referred to as a transparent display apparatus.

The transparent display apparatus is different from the conventional LCD apparatus in that a user may see the opposite side through the transparent display apparatus like a transparent glass window. The conventional display apparatus uses electrodes that are formed of an opaque material when a plurality of light emitting pixels that display images are formed, and thus, the light may not pass through the display apparatus. However, the transparent display apparatus may be fabricated by using a transparent material having excellent light transmittance to form wires supplying signals to the light emitting pixels and electrodes, or fabricated by realizing characteristics like a transparent glass plate by designing locations of the wires and the light emitting pixels in consideration of visual property of human beings.

The first display unit 150 includes a first region 151 formed of a transparent material that transmits the light, and a second region 152 connected to the first region 151 and displaying an image when a signal is applied from the control unit 140.

The first display unit 150 is coupled to the main body 10 to be slideable with respect to the main body 10. The main body 10 includes a receiving recess 10a in which the first display unit 150 is inserted. Guide portions 10b for guiding the sliding movement of the first display unit 150 are disposed on both sides of the receiving recess 10a. In an embodiment, the first display unit 150 may automatically move with respect to the main body 10 by using a driving unit such as a motor. In another embodiment, the first display unit 150 may be disposed to be moved manually, and thus, the user may push the first display unit 150 with respect to the main body 10.

As the first display unit 150 slides along the guide portions 10b, the first region 151 may be moved between a protruding position from the main body 10 and a receiving position where the first region 151 is received in the main body 10.

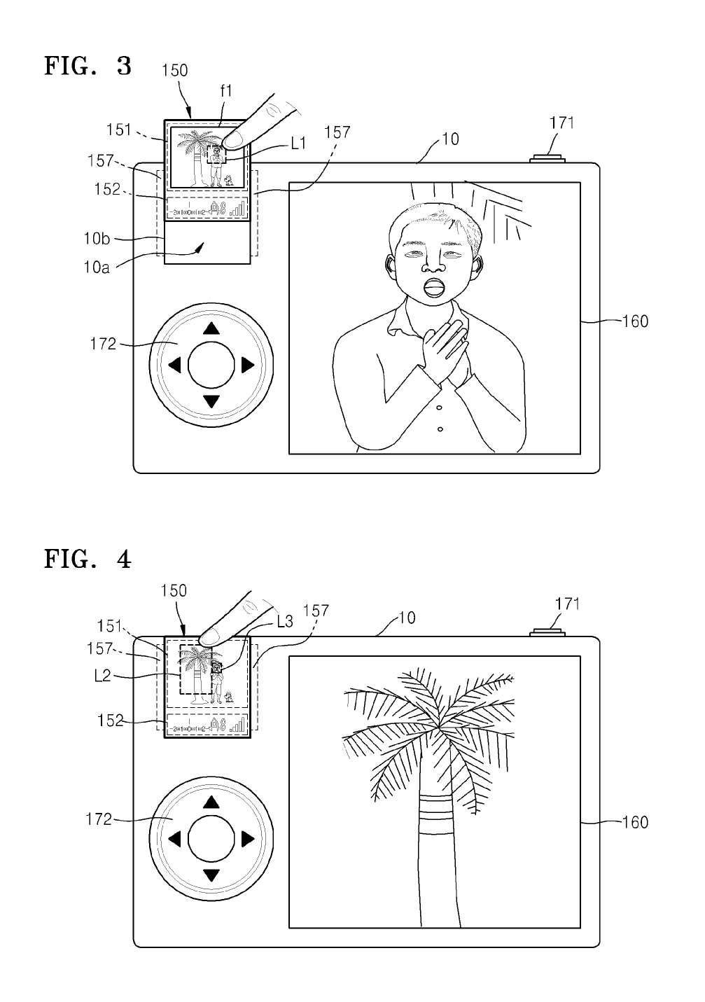

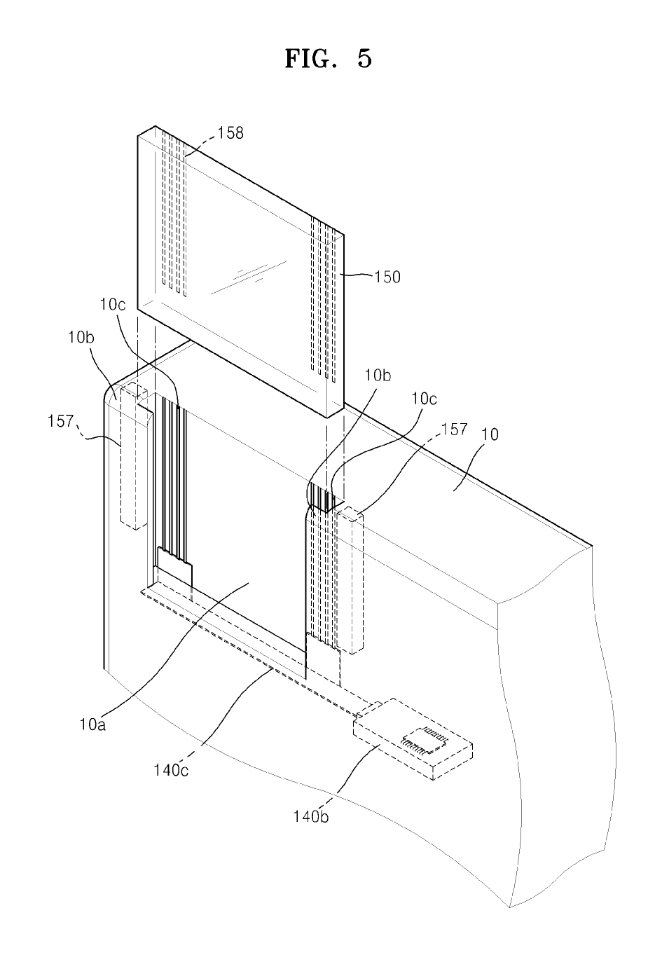

FIG. 3 is a rear view showing an operation example of the photographing apparatus of FIG. 2, and FIG. 4 is a rear view showing another operation example of the photographing apparatus of FIG. 2.

FIGS. 2 and 3 illustrate the protruding position where the first region 151 protrudes from the main body 10, and FIG. 4 illustrates the receiving position where the first region 151 is received in the main body 10. While the first region 151 moves to the protruding position, the second region 152 slides along the guide portions 10b and may be connected to the main body 10.

The second region 152 may be formed to have the same structure as the first region 151, and may be realized as the transparent display; however, the invention is not limited thereto. That is, since the second region 152 does not protrude from the main body 10, the second region 152 may be the general display apparatus that is conventionally used. Therefore, the second region 152 may include a backlight (not shown) to display photographing information, information about the image, or the image to the user.

Referring to FIG. 3, when the first region 151 is in the protruding position due to the movement of the first display unit 150, the user may observe the image of the subject that is to be photographed and may adjust a composition for the photographing. As described above, a function of displaying the image of the subject optically is referred to as an optical view finder (OVF) function.

In an embodiment, to perform the OVF function, the first display unit 150 does not display any kind of image on the first region 151 to transmit the image of the subject. In the first region 151, a composition frame f1 may be formed. The composition frame f1 is a mark for helping the user observe the subject and compose the frame while the image of the subject passes through the first region 151.

The composition frame f1 may be formed by printing a square mark on a portion corresponding to the first region 151 in the transparent panel of the first display unit 150. In an embodiment, the composition frame f1 may be represented to overlap with the light passing through the first region 151 by applying a signal to the first region 151 without printing an additional mark on the first region 151.

While performing the OVF function by the first region 151, the second region 152 of the first display unit 150 may display information for the photographing operation. The information for the photographing operation may include information notifying an exposure, a tone adjustment, photographing of a still image or moving picture, and information notifying communication state.

The first display unit 150 may be formed as a touch panel that senses a touch operation onto a surface thereof and generates a signal corresponding to the touched location. FIGS. 3 and 4 illustrate operations when the first display unit 150 is formed as the touch panel.

During performing the OVF function, the first display unit 150 may display the information about the photographing region on the first region 151 to overlap with the light passing through the first display unit 150. FIG. 3 illustrates an example of a photographing region frame L1 designated by the user as an example of the information about the photographing region.

When the user designates the region to be photographed by using the photographing region frame L1, the second display unit 160 may display an expanded image of a part of the subject, which corresponds to the photographing region frame L1. The user may execute the photographing operation, or may adjust or change the photographing region after identifying the magnified image of the photographing regions selected by the user through the second display unit 160.

The information about the photographing region that is displayed on the first region 151 to overlap with the light passing through the first display unit 150 during performing the OVF function is not limited to the mark representing the photographing region. In an embodiment, the information about the photographing region may include a mark denoting a recognized face when the face of a person is recognized, a mark denoting a focal area corresponding to an object that is automatically focused, and a mark representing directions in relation to geography of the space where the photographing is performed.

The first region 151 may perform various additional functions, besides the OVF function. For example, when an automatic photographing is performed, a number may be represented at the instant when the photographing is made to show the user the time sequence of the photographing.

In addition, a geographic information sensor for sensing a current geographic location may be installed in the photographing apparatus, and then, information for realizing an augmented reality (AR) function by using the geographic information sensor may be displayed on the first region 151. For example, if the user wants to photograph a building, information about an address of the subject, that is, the building, information about shop names or product names may be displayed on the first region 151.

Referring to FIG. 4, when the first region 151 is in the receiving position due to the movement of the first display unit 150, the first display unit 150 may display an image on the first region 151. The first display unit 150 may display the image on the first region 151 by the signal applied from the display control unit 144 of the control unit 140 shown in FIG. 1.

The display control unit 144 may displays a live view image obtained by the imaging unit 120 on the first display unit 150, and thus, the user may adjust the composition for the photographing while observing the image of the subject to be photographed through the first region 151. As described above, a function of electrically displaying the image of the subject is referred to as an electronic view finder (EVF) function.

Since the first region 151 of the first display unit 150 is formed as the transparent display, a backlight 157 may be mounted in the main body 10 for performing the EVF function when the first region 151 is in the receiving position. The backlight 157 is disposed on portions of the guide portions 10b corresponding to both sides of the first display unit 150 so as to provide the first region 151 that is in the receiving position with the light to display images.

The information about the photographing region may be displayed on the first region 151 when the EVF function is executed. The information about the photographing region may include a photographing region frame L2 designated by the user, a frame L3 denoting a recognized face of a human being, and a frame (not shown) representing a focal area.

Like the OVF function, during performing the EVF function, when the user designates a region to be photographed by using the photographing region frame L2, the second display unit 160 may display an expanded image of the part of the subject, which corresponds to the photographing region frame L2.

FIG. 5 is an expanded view of an example of a part of the photographing apparatus shown in FIG. 1.

In the embodiment illustrated in FIG. 5, the main body 10 of the photographing apparatus includes the guide portions 10b for supporting the first display unit 150 to be slid. The guide portions 10b include connecting portions 10c that are electrically connected to the first display unit 150 while the first display unit 150 moves along the guide portions 10b. The first display unit 150 includes connection terminals 158 corresponding to the connecting portions 10c on both sides thereof.

The connecting portions 10c extend from the guide portions 10b along with the sliding direction of the first display unit 150. The connecting portions 10c may be formed by coating or depositing an electric insulating material on inner portions of the guide portions 10b, or disposing a printed circuit board having a plurality of wires extending in a direction in which the guide portions 10b extend.

A circuit board 140b is installed in the main body 10 as an example of the control unit 140. An end of each of the connecting portions 10c is electrically connected to a flexible circuit board 140c. Since the flexible circuit board 140c is connected to the circuit board 140b, the connecting portions 10c are electrically connected to the circuit board 140b.

According to the above structure, the control signal of the control unit 140 may be supplied to the first display unit 150 well via the connecting portions 10c when the first display unit 150 slides along the guide portions 10b.

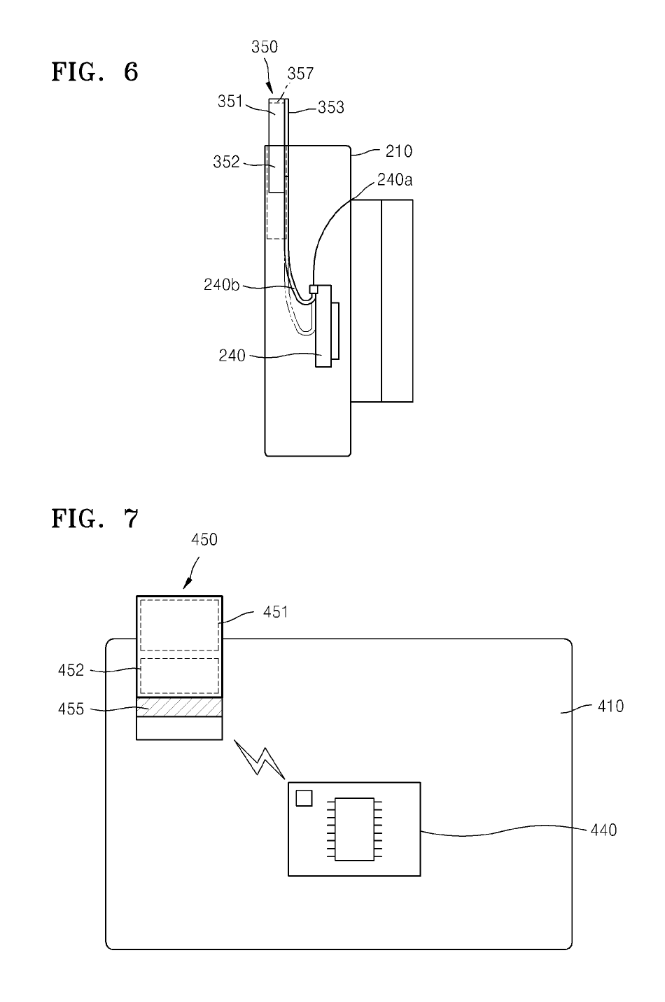

FIG. 6 is a schematic view of some components in a photographing apparatus according to another embodiment of the invention.

The embodiments of the invention are not limited to the connecting structure between the first display unit 150 and the connecting portions 10c illustrated in FIG. 5, and thus, the connecting structure may be variously modified.

FIG. 6 is a diagram illustrating another example of an electric connection between a first display unit 350 that is disposed in a main body 210 of the photographing unit to be slideable and a control unit 240 disposed in the main body 210.

The first display unit 350 is disposed on an upper portion of the main body 210 to be slideable with respect to the main body 210. The first display unit 350 includes a first region 351 formed using a transparent display, and a second region 352 connected to the first region 351 and maintaining a connecting status to the main body 210.

A shielding portion 353 is disposed on a surface of the first display unit 350. The light shielding portion 353 is driven when an electric signal is applied thereto to block the transmission of the light through the first region 351. The light shielding portion 353 may be formed as a liquid crystal apparatus or a mechanical shutter apparatus, for example.

In addition, the first display unit 350 may include a backlight 357 on an upper edge portion thereof. The backlight 357 is driven in a state where the light is shielded by the light shielding portion 353 so that the image may be displayed on the first display unit 350 by using the light provided by the backlight 357.

The first display unit 350 and the light shielding portion 353 are electrically connected to the control unit 240 via a flexible circuit board 240b. An end of the flexible circuit board 240b is connected to the control unit 240 via a connector 240a. The flexible circuit board 240b electrically connects the control unit 240 and the first display unit 350 and the light shielding portion 353 to each other, and may be curved flexibly in response to the sliding movement of the first display unit 350.

As denoted by a dotted line in FIG. 6, when the first region 351 is in a receiving position in the main body 210 by the sliding movement of the first display unit 350, the flexible circuit board 240b is curved downward and the electric connection state between the control unit 240 and the first display unit 350 may be stably maintained.

FIG. 7 is a schematic view schematically illustrating components in a photographing apparatus according to another embodiment of the invention.

In the photographing apparatus illustrated in FIG. 7, a control unit 440 disposed in a main body 410 and a first display unit 450 may be connected to each other through wireless communication.

The first display unit 450 that is slideably coupled to the main body 410 includes a first region 451 and a second region 452. In addition, since the first display unit 450 includes a wireless communication unit 455, the wireless connection between the control unit 440 and the first display unit 450 may be made via the wireless communication unit 455.

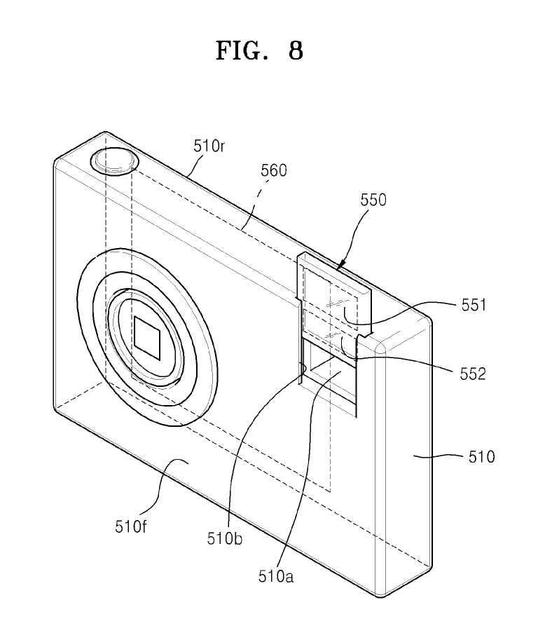

FIG. 8 is a perspective view schematically illustrating an example of a photographing apparatus according to another embodiment of the invention.

In the photographing apparatus according to the embodiment of FIG. 8, a location of a first display unit 550 disposed in a main body 510 of the photographing apparatus is changed. That is, the first display unit 550 is disposed on a front surface 510f of the main body 510 to be slideable with respect to the first display unit 550. A receiving recess 510a in which the first display unit 550 is received is formed in the front surface 510f of the main body 510, and guide portions 510b for guiding the sliding movement of the first display unit 550 are formed on both sides of the receiving recess 510a. A second display unit 560 is disposed on a rear surface 510r of the main body 510.

The user may execute various functions by using the photographing apparatus having the above structure. That is, when the user photographs the subject while seeing the rear surface 510r of the main body 510, as shown in FIGS. 2 through 4, the first region 551 protrudes from the main body 510 so that the light may pass through the first region 551 or the information about the photographing is displayed to overlap with the light passing through the first region 551 in order to use the OVF function.

In addition, when the user photographs the subject while seeing the front surface 510f of the main body 510, a self-photographing function may be executed in a state where the first region 551 is received in the main body 510. The self-photographing function is a function allowing the user to photograph himself/herself while seeing his/her face by displaying the user on the first region 551 that is exposed to the front surface 510f of the main body 510. During executing the self-photographing function, various information for the photographing may be displayed on the second region 552.

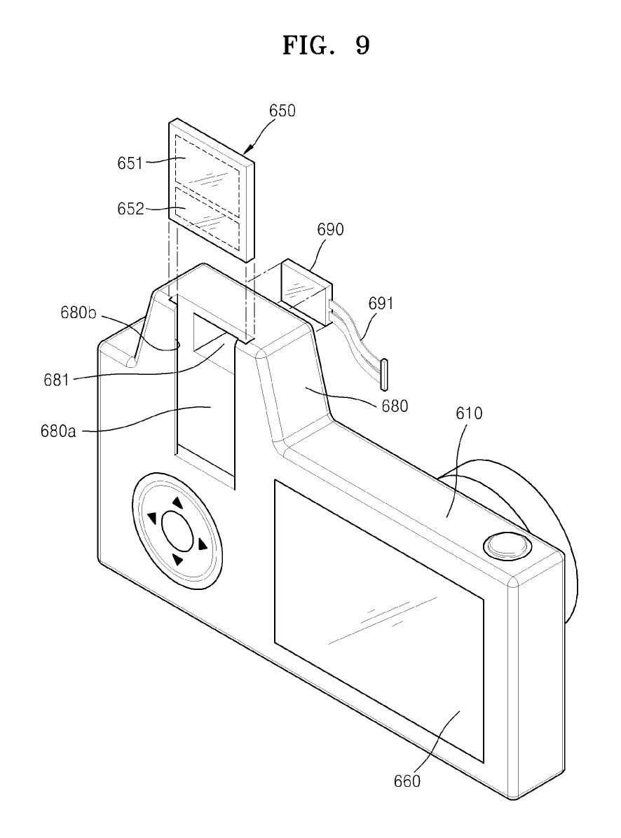

FIG. 9 is a perspective view schematically illustrating an example of a photographing apparatus according to another embodiment of the invention.

In the photographing apparatus shown in FIG. 9, a main body 610 of the photographing apparatus includes a protrusion portion 680 protruding upward, and a first display unit 650 is installed on the protrusion portion 680.

The first display unit 650 is received in a receiving recess 680a formed in the main body 610, and the receiving recess 680a includes guide portions 680b that support the first display unit 650 to be slid. The first display unit 650 includes a first region 651 formed as a transparent display apparatus, and a second region 652 extending from the first region 651.

The protrusion portion 680 includes a through hole 681 through which the light may pass to the first region 651. When the first display unit 650 slides along the guide portions 680b of the protrusion portion 680 to a protruding position, where the first region 651 corresponds to the through hole 681, an image of the subject that is incident through the through hole 681 passes through the first region 651 to the user, that is, the OVF function may be performed.

The protrusion portion 680 may include a light shielding portion 690 operating to block or open the through hole 681. A signal may be applied to the light shielding portion 690 via a flexible circuit board 691 from a control unit (not shown) of the photographing apparatus. The light shielding portion 690 may block or open the through hole 681 according to the signal. Embodiments of the invention are not limited to the above structure of the light shielding portion 690, the light shielding portion 690 may be formed by using a mechanical shutter, rather than the liquid crystal apparatus.

When the first region 651 is in the protruding position, the light shielding portion 690 blocks the light passing through the through hole 681 and the image is displayed on the first region 651, that is, the EVF function may be performed. During performing the EVF function, the information about the photographing may be displayed on a second region 652 of the first display unit 650.

In the embodiment shown in FIG. 9, the first display unit 650 includes the first region 651 and the second region 652; however, the invention is not limited thereto. That is, the first display unit 650 may include only the first region 651, and in this case, the OVF function may be realized so that the subject to be photographed may be observed through the through hole 681 of the protrusion portion 680 when the first region 651 is moved to the receiving position where the first region 651 is received in the main body 610 from the through hole 681. When the OVF function is performed by using the through hole 681, the information about the photographing may be displayed on the first region 651.

Although not shown in FIG. 9, a lens for condensing the light incident from the subject and forming an image may be disposed in the through hole 681 for performing the OVF function.

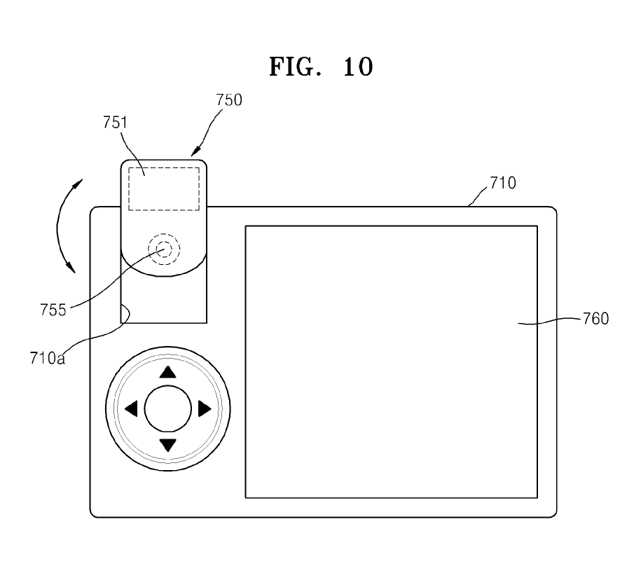

FIG. 10 is a rear view of an example of a photographing apparatus according to another embodiment of the invention.

In the photographing apparatus shown in FIG. 10, a first display unit 750 is disposed on a main body 710 so as to rotate a surface that is substantially parallel to a surface of the main body 710. The main body 710 may include a receiving recess 710a that may receive the first display unit 750. The first display unit 750 may be installed in the receiving recess 710a of the main body 710 to be rotatable by a rotating shaft 755.

FIG. 10 shows a state where the first display unit 750 is rotated to a protruding position where a first region 751 protrudes from a main body 710. When the first region 751 is in the protruding position, the OVF function may be performed so that the light incident from the subject may pass through the first region 751 or an image may be displayed on the first region 751 to overlap with the light passing through the first region 751. During performing the OVF function, information about the photographing or the image may be displayed on a second display unit 760 that is disposed on the main body 710.

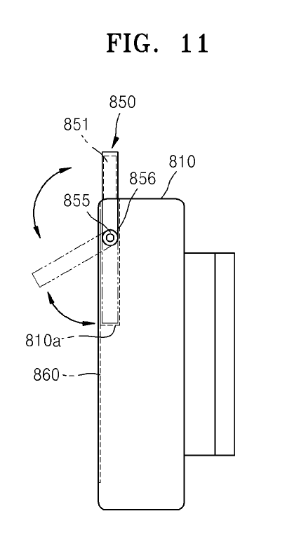

FIG. 11 schematically illustrates components of an example of a photographing apparatus according to another embodiment of the invention.

In the photographing apparatus shown in FIG. 11, a first display unit 850 may be installed on a main body 810 so as to be rotated in a direction substantially perpendicular to a surface of the main body 810. The main body 810 may include a receiving recess 810a in which the first display unit 850 may be received. The first display unit 850 is installed in the receiving recess 810a of the main body 810 to be rotatable by a rotating shaft 855. The first display unit 850 is coupled to the rotating shaft 855 via a supporting portion 856.

FIG. 11 illustrates a state where the first display unit 850 is rotated such that the first region 851 protrudes out of the main body 810. When the first region 851 is in the protruding position, the OVF function may be performed, that is, the light incident from the subject may pass through the first region 851 or an image may be displayed on the first region 851 to overlap with the light passing through the first region 851. While performing the OVF function, information about the photographing or the image may be displayed on a second display unit 860 disposed on the main body 810.

As illustrated in FIG. 11, when the first display unit 850 is rotated downward, the first region 851 is moved to a receiving position where the first region 851 is received in a receiving recess 810a of the main body 810. When the first region 851 is in the receiving position, the EVF function, that is, displaying of the information about the photographing on the first region 851 or displaying a live view image obtained by an imaging unit (not shown) of the photographing apparatus, may be performed.

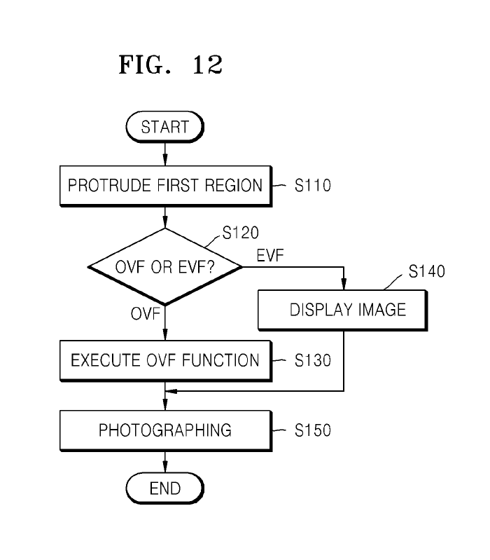

FIG. 12 is a flowchart illustrating processes of an example of a photographing method according to an embodiment of the invention.

The photographing method illustrated in FIG. 12 includes moving a first display unit that includes a first region, which is formed of a transparent material that transmits the light and may display an image to be overlapped with the light passing through the first region when a signal is applied thereto, with respect to a main body so that the first region protrudes out of the main body (S110), determining whether the OVF function is performed or the EVF function is performed (S120), if the OVF function is performed, providing an optical view finder image by transmitting the light through the first region that protrudes out of the main body (S130), and converting the light incident into the first region from at least a part of a subject into a signal representing an image and performing a photographing by using an imaging unit disposed in the main body (S150).

The operation of providing the optical view finder image (S130) may include displaying the image on the first region to be overlapped with the light passing through the first region. The image displayed on the first region may include information about a photographing region. The information about the photographing region may include a photographing region designated by the user, a mark denoting a recognized face, a mark denoting a focal area, and a mark representing directions relating to geography of a space where the photographing is performed.

When the EVF function is performed, the photographing (S150) may be performed after performing the operation of displaying the image on the first region (S140). In the operation of displaying the image on the first region (S140), external light incident into the first region is blocked, a live view image obtained by the imaging unit may be displayed on the first region or the information about the photographing may be displayed on the first region.

According to the photographing apparatus and method of the invention, the image light of the subject may pass through the first display unit, which is transparent and disposed to be movable on the main body of the photographing apparatus, or an image relating to the photographing region may be displayed on the light passing through the first display unit. Therefore, the OVF function and the EVF function may be provided conveniently without using components occupying a lot of space such as a pentaprism or a lens. Thus, the photographing apparatus may be designed to have a compact size and the user may conveniently use the photographing apparatus.

In addition, when the first display unit includes the first region and the second region, the first region may be used to perform the view finder function and the second region may be used to display information about the photographing, and accordingly, spaces of the photographing apparatus may be used effectively for the user to use the photographing apparatus conveniently.

In embodiments, the EVF function is performed (S120) without step S110 being performed so that the first region does not protrude out of the main body (S110), Photographing (S150) may then be performed with the first region not protruding out of the main body.

The invention provides the advantage of a photographing apparatus and method capable of providing both an electronic view finder function and an optical view finder function without using an element occupying a large space such as a pentaprism and a lens.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. A photographing apparatus comprising:
a main body;
an imaging unit installed in the main body configured to convert light incident on a subject into a signal representing an image;
a first display unit comprising a first region formed of a transparent material, wherein the first region is configured to transmit light incident to the subject passing through the first region and configured to display the image overlapped with the transmitted light if a signal is applied, and wherein the first display unit is disposed on the main body to be movable between a protruding position where the first region protrudes from the main body and a receiving position where the first region is received in the main body; and
a control unit installed in the main body configured to control the imaging unit, and configured to apply the signal to the first display unit to display the image overlapped with the transmitted light.

2. The photographing apparatus of claim 1, wherein when the first display unit moves to the protruding position, the first region displays information about a photographing region so that the information may overlap with the light passing through the first region.

3. The photographing apparatus of claim 2, wherein the first display unit further comprises a second region that is connected to the first region to display an image when a signal is applied to the second region, and the second region is connected to the main body while the first region moves to the protruding position.

4. The photographing apparatus of claim 1, wherein the second region displays information for a photographing operation.

5. The photographing apparatus of claim 1, wherein the first display unit is disposed to be slideable with respect to the main body.

6. The photographing apparatus of claim 5, further comprising a flexible circuit board, an end of which is connected to the first display unit and the other end of which is connected to the control unit, transmitting a signal between the control unit and the first display unit.

7. The photographing apparatus of claim 5, wherein the main body comprises guide portions supporting the first display unit slideably, and the guide portions comprise a connecting portion maintaining an electric connection to the first display unit that slides along the guide portions, and the connecting portion is electrically connected to the control unit.

8. The photographing apparatus of claim 1, wherein the first display unit and the control unit are wireless communicated with each other.

9. The photographing apparatus of claim 1, wherein the first display unit is rotatable along a surface that is parallel to a surface of the main body.

10. The photographing apparatus of claim 1, wherein the first display unit is rotatable in a direction perpendicular to the surface of the main body.

11. The photographing apparatus of claim 1, wherein the main body comprises a protrusion portion that protrudes outward from the main body so as to support the first region when the first display unit is in the protruding position, and the protrusion portion comprises a through hole for transmitting the light to the first region.

12. The photographing apparatus of claim 11, further comprising a light shielding portion installed on the protrusion portion to block the through hole when a signal is applied to the light shielding portion.

13. The photographing apparatus of claim 1, further comprising a light shielding portion coupled to the first region and blocking the light passing through the first region if a signal is applied to the light shielding portion.

14. The photographing apparatus of claim 1, wherein the first display unit is disposed on a rear surface of the main body, and the photographing apparatus further comprises a second display unit disposed on a side of the first display unit configured to display an image when a signal is applied to the second display unit.

15. The photographing apparatus of claim 1, wherein the first display unit is disposed on a front surface of the main body, and the photographing apparatus further comprises a second display unit disposed on a rear surface of the main body configured to display an image according to a signal.

16. The photographing apparatus of claim 15, further comprising a user input unit for selecting a part on the first region of the first display unit, and wherein the second display unit is configured to display an expanded image of the selected part on the first region of the first display unit.

17. The photographing apparatus of claim 16, wherein the user input unit comprises a touch screen disposed on a surface of the first region.

18. A photographing method comprising:
in response to a first display unit comprising a first region being moved with respect to a main body so that the first region protrudes out of the main body,
providing an optical view finder image by transmitting light incident to a subject that passes through the first region, wherein the first region is formed of a transparent material configured to transmit light and configured to display an image overlapped with the transmitted light if a signal is applied; and
converting light incident on the subject into a signal representing the image by using an imaging unit disposed in the main body.

19. The photographing method of claim 18, wherein the providing of the optical view finder image comprises displaying the image on the first region to be overlapped with the transmitted light.

20. The photographing method of claim 19, wherein the first display unit further comprises a second region that is connected to the first region and the method further comprises: displaying an image according to an applied signal on the second region, wherein the second region is connected to the main body when the first region is in the protruding position, and wherein the providing of the optical view finder image further comprises displaying information for photographing on the second region.
